(19) United States
(12) Patent Application Publication
(10) Pub. No.: US 2012/0314064 A1
(43) Pub. Date: Dec. 13, 2012

(54) ABNORMAL BEHAVIOR DETECTING APPARATUS AND METHOD THEREOF, AND VIDEO MONITORING SYSTEM

(75) Inventors: Zhou LIU, Beijing (CN); Weiguo Wu, Beijing (CN)

(73) Assignee: Sony Corporation, Tokyo (JP)

(21) Appl. No.: 13/477,330

(22) Filed: May 22, 2012

(30) Foreign Application Priority Data
Jun. 13, 2011 (CN) 201110166895.2

(51) Int. Cl. H04N 7/18

(52) U.S. Cl. 348/143; 348/E07.085

(57) ABSTRACT

The disclosure provides abnormal behavior detecting apparatus and method. The apparatus may include: an extracting device configured to extract, from a video segment to be detected, an image block sequence containing a plurality of image blocks corresponding to a moving range of an object in each image frame in the video segment; a feature calculating device configured to calculate motion vector features of the image block sequence; and an abnormal behavior detecting device comprising two or more stages of classifiers that are connected in series. The classifiers are configured to receive the image block sequence and the motion vector features stage by stage and detect the abnormal behavior of the object. If a previous stage of classifier determines that the to image block sequence contains an abnormal behavior, a next stage of classifier further receives and detects the image block sequence, until last stage of classifier.

### CROSS REFERENCE TO RELATED APPLICATION

The application claims priority to Chinese patent application No. 201110166895.2 filed with the Chinese patent office on Jun. 13, 2011, entitled “Abnormal Behavior Detecting Apparatus and Method, as Well as Apparatus and Method of Generating such Detecting Apparatus”, the contents of which is incorporated herein by reference as if fully set forth.

### FIELD

The disclosure relates to object detection in video, and particularly, to an apparatus and method of detecting an abnormal behavior of an object in video as well as an apparatus and method of generating the same.

### BACKGROUND

Visual monitoring of dynamic scenarios recently is attracting much attention. In the visual monitoring technique, the image sequence captured by cameras is analyzed to comprehend the behaviors of an object being monitored and a warning is reported when an abnormal behavior of the object is detected. The detection of abnormal behaviors is an important function of intelligence visual monitoring and thus the study in the detection techniques of abnormal behaviors is significant in the art.

### SUMMARY

The following presents a simplified summary of the disclosure in order to provide a basic understanding of some aspects of the disclosure. This summary is not an exhaustive overview of the disclosure. It is not intended to identify key or critical elements of the disclosure or to delineate the scope of the disclosure. Its sole purpose is to present some concepts in a simplified form as a prelude to the more detailed description that is discussed later.

According to an aspect of the disclosure, there is provided an apparatus of generating a detector for detecting an abnormal behavior of an object in video. The apparatus of generating the detector includes: an extracting device configured to extract, from each of a plurality of video samples, an image block sequence containing image blocks corresponding to a moving range of the object in each image frame of the video sample; a feature calculating device configured to calculate motion vector features in the image block sequence extracted from each video sample; and a training device configured to train a first stage of classifier by using a plurality of image block sequences extracted from the plurality of video samples and the motion vector features thereof, classify the plurality of image block sequences by using the first stage of classifier, and train a next stage of classifier by using image block sequences, among the plurality of image block sequences, that are determined by the first stage of classifier as containing the abnormal behavior of the object, so as to obtain two or more stages of classifiers, wherein the two or more stages of classifiers are connected in series to form the detector for detecting an abnormal behavior of an object in video.

According to another aspect of the disclosure, there is provided a method of generating a detector for detecting an abnormal behavior of an object in video. The method of generating the detector includes: extracting, from each of a plurality of video samples, an image block sequence containing image blocks corresponding to a moving range of the object in each image frame of the video sample; calculating motion vector features in the image block sequence extracted from each video sample; and training a first stage of classifier by using a plurality of image block sequences extracted from the plurality of video samples and the motion vector features thereof, classifying the plurality of image block sequences by using the first stage of classifier, and training a next stage of classifier by using image block sequences, among the plurality of image block sequences, that are determined by the first stage of classifier as containing the abnormal behavior of the object, so as to obtain two or more stages of classifiers, wherein the two or more stages of classifiers are connected in series to form the detector for detecting an abnormal behavior of an object in video.

According to another aspect of the disclosure, there is provided an apparatus of detecting an abnormal behavior of an object in video including: an extracting device, configured to extract, from a video segment to be detected, an image block sequence containing image blocks corresponding to a moving range of an object in each image frame in the video segment; a feature calculating device, configured to calculate motion vector features in the image block sequence; and an abnormal behavior detecting device comprising two or more stages of classifiers that are connected in series, wherein each stage of classifier is configured to detect the abnormal behavior of the object, and the image block sequence and the motion vector features are input into the two or more stages of classifiers stage by stage, if a previous stage of classifier determines that the image block sequence contains an abnormal behavior, the image block sequence is input into a next stage of classifier, until to last stage of classifier.

According to another aspect of the disclosure, there is provided a method of detecting an abnormal behavior of an object in video including: extracting, from a video segment to be detected, an image block sequence containing image blocks corresponding to a moving range of an object in each image frame in the video segment; calculating motion vector features in the image block sequence; and inputting the image block sequence and the motion vector features into two or more stages of classifiers that are connected in series stage by stage, wherein each stage of classifier is capable of detecting the abnormal behavior of the object, and if a previous stage of classifier determines that the image block sequence contains an abnormal behavior, the image block sequence is input into a next stage of classifier, until to last stage of classifier.

According to another aspect of the disclosure, there is provided a video monitoring system. The system includes a video collecting device configured to capture a video of a monitored scenario and an abnormal behavior detecting apparatus configured to detect an abnormal behavior of an object in the video. The abnormal behavior detecting apparatus includes: an extracting device, configured to extract, from a video segment to be detected, an image block sequence containing image blocks corresponding to a moving range of an object in each image frame in the video segment; a feature calculating device, configured to calculate motion vector features in the image block sequence; and n abnormal behavior detecting device comprising two or more stages of classifiers that are connected in series, wherein each stage of classifier is configured to detect the abnormal behavior of the object, and the image block sequence and the motion vector features are input into the two or more stages of classifiers stage by stage, if a previous stage of classifier determines that the image block sequence contains an abnormal behavior, the image block sequence is input into a next stage of classifier, until to last stage of classifier.

In addition, some embodiments of the disclosure further provide computer program for realizing the above method.

Further, some embodiments of the disclosure further provide computer program products in at least the form of computer-readable recoding medium, upon which computer program codes for realizing the above method are recorded.

### BRIEF DESCRIPTION OF DRAWINGS

The above and other objects, features and advantages of the embodiments of the disclosure can be better understood with reference to the description given below in conjunction with the accompanying drawings, throughout which identical or like components are denoted by identical or like reference signs. In addition the components shown in the drawings are merely to illustrate the principle of the disclosure. In the drawings:

FIG. 1 is a schematic flow chart showing the method of generating a detector for detecting an abnormal behavior of an object in video according to an embodiment of the disclosure;

FIG. 2 is a schematic flow chart showing the method of generating two or more stages of classifiers that are connected in series;

FIG. 3 is a schematic flow chart showing an example of extracting an image block sequence from video images;

FIG. 4 is a schematic flow chart showing the method of generating a detector for detecting an abnormal behavior of an object in video according to another embodiment of the disclosure;

FIG. 5 is a schematic flow chart showing another example of extracting an image block sequence from video images;

FIG. 6 is a schematic block diagram showing the structure of an apparatus of generating a detector for detecting an abnormal behavior of an object in video according to an embodiment of the disclosure;

FIG. 7 is a schematic block diagram showing the structure of an apparatus of generating a detector for detecting an abnormal behavior of an object in video according to another embodiment of the disclosure;

FIG. 8 is a schematic flow chart showing the method of detecting an abnormal behavior of an object in video according to an embodiment of the disclosure;

FIG. 9 is a schematic flow chart showing the method of detecting an abnormal behavior of an object in video according to another embodiment of the disclosure;

FIG. 10 is a schematic flow chart showing an example of detecting an abnormal behavior of an object in video by using two or more stages of classifiers that are connected in series;

FIG. 11 is a schematic flow chart showing an example of determining whether an image block sequence contains an abnormal behavior of an object;

FIG. 12 is a schematic flow chart showing another example of detecting an abnormal behavior of an object in video by using two or more stages of classifiers that are connected in series;

FIG. 13 is a schematic block diagram illustrating the structure of an apparatus of detecting an abnormal behavior of an object in video according to an embodiment of the disclosure;

FIG. 14 is a schematic block diagram illustrating the structure of the abnormal behavior detecting device shown in FIG. 13;

FIG. 15 is a schematic block diagram illustrating the structure of an apparatus of detecting an abnormal behavior of an object in video according to another embodiment of the disclosure;

FIG. 16 is a schematic block diagram illustrating the structure of the abnormal behavior detecting device shown in FIG. 15;

FIG. 17 is a schematic block diagram illustrating another example of the abnormal behavior detecting device shown in FIG. 13;

FIG. 18 is a schematic diagram showing the process of generating a motion vector feature; and

FIG. 19 is a schematic block diagram illustrating the structure of a computer for realizing the embodiment or example of the disclosure.

### DETAILED DESCRIPTION

Some embodiments of the present disclosure will be described in conjunction with the accompanying drawings hereinafter. It should be noted that the elements and/or features shown in a drawing or disclosed in an embodiments may be combined with the elements and/or features shown in one or more other drawing or embodiments. It should be further noted that some details regarding some components and/or processes irrelevant to the disclosure or well known in the art are omitted for the sake of clarity and conciseness.

Some embodiments of the present disclosure provide an apparatus and method of generating a detector for detecting an abnormal behavior of an object in video as well as an apparatus and method of detecting an abnormal behavior of an object in video.

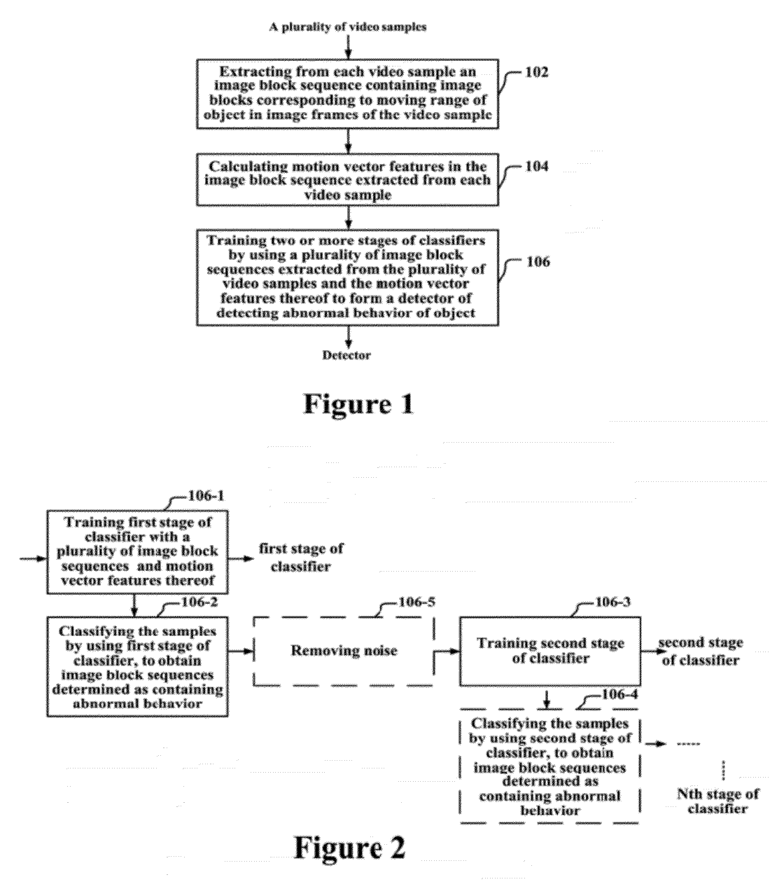

FIG. 1 is a schematic flow chart showing the method of generating a detector according to an embodiment of the disclosure. The detector is configured to detect an abnormal behavior of an object in video.

As shown in FIG. 1, the method includes steps 102, 104 and 106. In the method shown in FIG. 1, multiple video samples are used to generate a detector for detecting an abnormal behavior of an object in video. The generated detector includes two or more stages of classifiers that are connected in series.

To generate the detector for detecting an abnormal behavior of an object in video, video samples to be used in training are prepared. Each video sample contains multiple frames of images, and contains behaviors of an object (e.g. a person, an animal, or a vehicle, or the like) to be detected. Based on actual practice, the behaviors of an object can be classified into normal behaviors, such as walking, talking, and the like, and abnormal behaviors, such as falling down, fighting, running, and the like. Accordingly, a video sample that contains a normal behavior is referred to as a normal sample, and a video sample that contains an abnormal behavior is referred to as an abnormal sample.

In step 102, a region containing a moving object is extracted from each video sample of a plurality of video samples. In other words, the region containing the moving object is separated from the background and the region will be used in the following step of judging whether it the moving object's behavior is abnormal or not. A video sample may be a video image sequence in which the normal behaviors of an object has been labeled, or alternatively, may be a video image sequence which is not labeled. In general video monitoring practice, the number of normal samples is generally much larger than that of abnormal samples. In the embodiments or examples of the disclosure, the set of training samples to be used may include both normal samples and abnormal samples, or alternatively, the set f training samples to be used may include only normal samples.

Particularly, the moving range of the object to be detected may be determined based on the video samples, then an image block corresponding to the moving range is extracted from each image frame of each video sample which containing a plurality of frames of images. A plurality of image blocks extracted from the plurality of frames of images of each video sample constitute the image block sequence of the video sample. That is, the image block sequence extracted from a video sample includes the image block sequence, corresponding to the moving range of the object to be detected, in each of the image frames of this video sample.

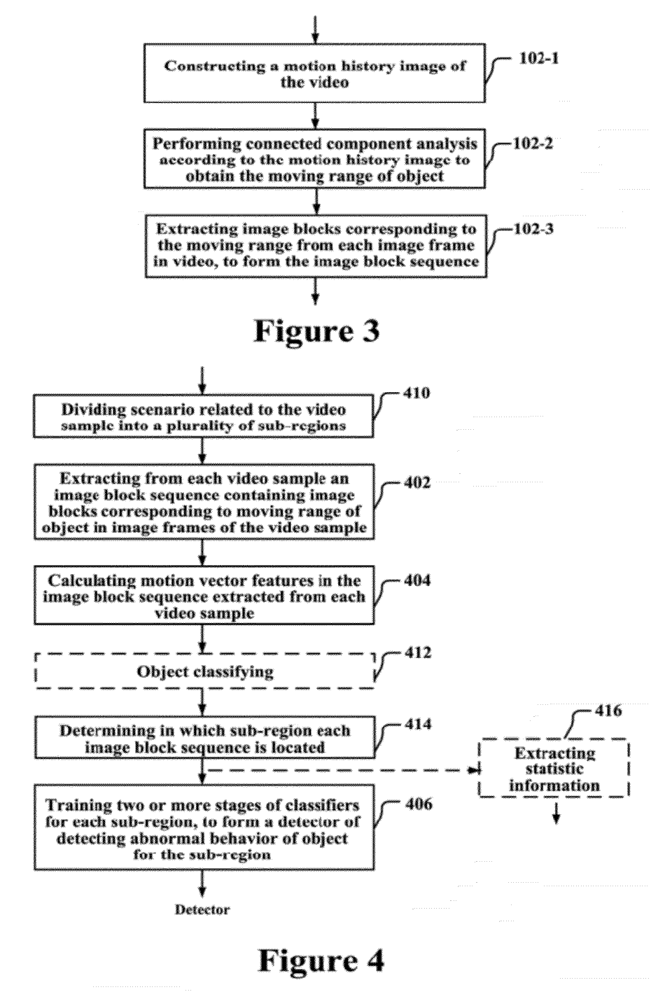

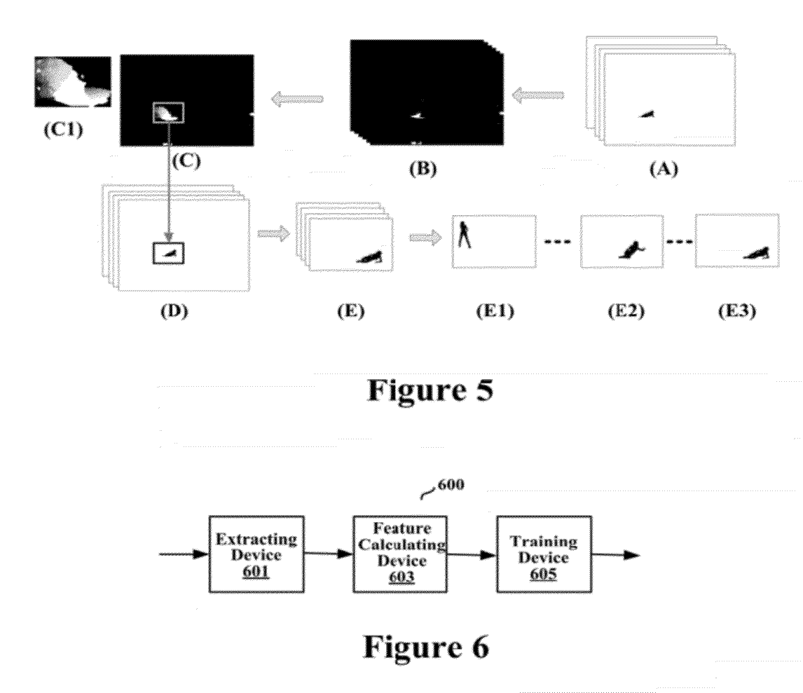

Any appropriate method can be used to extract the image block sequence corresponding to the moving range of the object to be detected from a video sample. As an example, the method described below with reference to FIG. 3 and FIG. 5 may be used to extract the image block sequence from a video sample.

Then in step 104, a motion vector feature may be extracted from each image block sequence. That is, the motion vector feature of the image block sequence extracted from each video sample is calculated.

As an example, the motion vector may be extracted by calculating the motion vector direction histogram of each image block sequence. Optionally, the motion vector direction histogram may be normalized motion vector direction histogram. The motion vector may be motion vector of pixels, or may be motion vector of blocks.

The calculation of the motion vector direction histogram is generally based on the foreground image. The foreground image may be extracted from a video image by using any appropriate method, such as a foreground detection algorithm based on pixels, a foreground detection algorithm based on contour neighboring information, or the like, the description of which is not detailed herein. The foreground detection algorithms based on pixels include, for example, Temporal differencing algorithm and Background subtraction algorithm. Reference may be made to Chris Stauffer and W. E. L. Grimson, “Adaptive background mixture models for real-time tracking” (1999 IEEE Computer Society Conference on Computer Vision and Pattern Recognition (CVPR'99)—Volume 2, pp. 2246, 1999), in which a method of modeling background by using Gaussian mixture model and a method of distinguishing the foreground and the background from each other are described.

The motion vector direction histogram can be calculated by using any appropriate method, for example, the calculating method of motion vector direction histogram described in Hu et al., “Anomaly Detection Based on Motion Direction” (ACTA AUTOMATICA SINICA, Vol. 34, No. 11, November, 2008), the description of which is omitted herein.

The direction ranges of a motion vector direction histogram (e.g. the width and number of the direction ranges) may be configured arbitrarily. As a particular example, 16 direction ranges including [−π/8, π/8], [0, π/4], [π/8, 3π/8], [π/4, π/2], [3π/8], [5π/8], [π/2, 3π/4], [5π/8, 7π/8], [3π/4, π], [7π/8, 9π/8], [π, 5π/4], [9π/8, 11π/8], [5π/4, 3π/2], [11π/8, 13π/8], [3π/2, 7π/4], [13π/8, 15π/8], and [7π/4, 2π] may be used.

For each image block sequence, the motion vector direction histograms of all the image blocks in this image block sequence constitute the feature vector of this image block sequence. Supposing the number of direction ranges of the motion vector direction histogram is denoted as K and the number of image blocks in the image block sequence is denoted as N, then each motion vector direction histogram contains data x_{i,j}, where 1<i≦K, 1<j≦N, x_{i,j} represents the number (or normalized number) of motion vectors whose directions are within the direction range i and which is obtained by performing statistics with respect to the jth image block in the image block sequence. The feature vector thus formed contains all the data x_{i,j}. The sequence of all the data x_{i,j} in the feature vector may be configured arbitrarily. As an example, the feature vector may be (x_{1,1}, x_{1,2}, . . . , x_{1,N}, x_{2,1}, x_{2,2}, . . . , x_{2,N}, . . . , x_{K,1}, x_{K,2}, . . . , x_{K,N}).

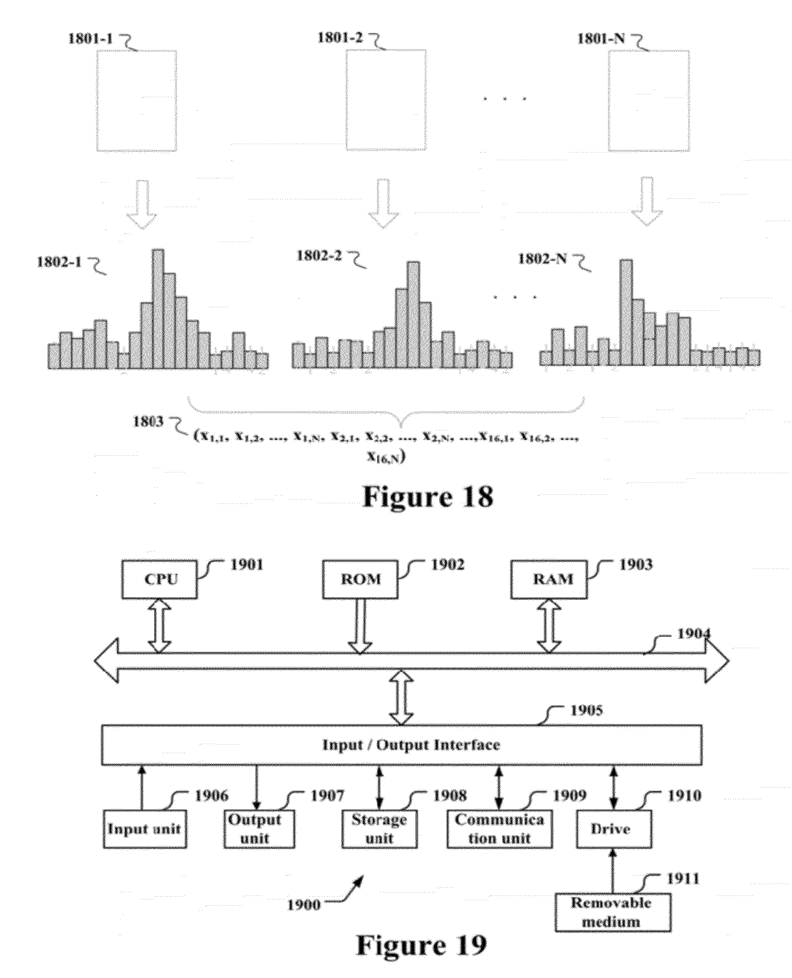

FIG. 18 illustrates an example of the process of generating a feature vector. As shown in FIG. 18, it is supposed that the image block sequence contains image blocks 1801-1, 1801-2, . . . , and 1801-N. The motion vector direction histogram of each of the image blocks 1801-1, 1801-2, . . . , 1801-N is calculate and denoted by 1802-1, 1802-2, . . . , or 1802-N. The motion vector direction histogram contains the 16 direction ranges described above. The motion vector direction histograms 1802-1, 1802-2, . . . , and 1802-N of all the image blocks in the image block sequence constitute a feature vector 1803, i.e. (x_{1,1}, x_{1,2}, . . . , x_{1,N}, x_{2,1}, x_{2,2}, . . . , x_{2,N}, . . . , x_{16,1}, x_{16,2}, . . . , X_{16,N}).

Then in step 106, a classifier is trained by using a plurality of image block sequences extracted from a plurality of video samples and the motion vector feature of each of the image block sequences.

FIG. 2 shows an example of the method of training a classifier. As shown in FIG. 2, in step 106-1 a first stage of classifier is trained by using the plurality of image block sequences extracted from all of the video samples and the motion vector feature of each of the image block sequences. Then in step 106-2, the plurality of image block sequences are classified by using the first stage of classifier, to obtain image block sequences, among the plurality of image block sequences, that are determined by the first stage of classifier as containing abnormal behaviors of the object (i.e. the samples that can not be described by the first stage of classifier). Then in step 106-3, a second stage of classifier is trained by using these image block sequences that are determined by the first stage of classifier as containing abnormal behaviors of the object. In step 106-4, these image block sequences that are determined by the first stage of classifier as containing abnormal behaviors of the object are further classified by using the second stage of classifier, to obtain image block sequences, among these image block sequences that are determined by the first stage of classifier as containing abnormal behaviors of the object, that are determined by the second stage of classifier as containing abnormal behaviors of the object. Then these image block sequences that are determined by the second stage of classifier as containing abnormal behaviors of the object may be used to train the next stage of classifier, and the rest may be deduced by analogy. The training may be stopped when the number of image block sequences that are determined by a previous stage of classifier as containing abnormal behavior of the object is less than a predetermined threshold value (it should be noted this threshold value may be predetermined based on the actual application scenarios and should not be limited to any particular value). In this way N stages of classifiers may be obtained (N≧2). Then the N stages of classifiers are connected in series stage by stage, to form a detector for detecting abnormal behaviors of the object in video.

By using the method shown in FIG. 1, two or more stages of classifiers that are connected in series may be obtained, where each stage of classifier is trained by using the samples that are determined by the previous stage of classifier as containing abnormal behavior of the object. In this way, the type of samples whose number is small among the training samples may be modeled, thus decreasing the error detection in the following abnormal behavior detection.

Each stage of classifier may be trained by using any appropriate method. As an example, each stage of classifier of the two or more stages of classifiers that are connected in series may be a one class support vector machine, that is, the two or more stages of classifiers that are connected in series may include one class support vector machines connected in series. In general video monitoring practice, the number of normal samples is generally much larger than that of abnormal samples. Thus the set of training samples generally includes very few abnormal samples, or even includes only normal samples. By using the one class support vector machine, the features of one class of samples (e.g. the normal samples whose number is large) may be modeled, to improve the accuracy of abnormal behavior detection. As another example, other training method, such as the training method based on a probability distribution model (the probability distribution model herein includes but not limited to Gaussian mixture model, Hidden Markov model, and Conditional Random Fields, and the like), may be used, the description of which is omitted herein.

Referring back to FIG. 2, as an example, before training the next stage of classifier by using the image block sequences that are determined by the previous stage of classifier as containing abnormal behavior of the object, the method may further include a step of removing noise. As shown by step 106-5, this step may be performed before step 106-3, to remove the noise from the image block sequences that are determined by the first stage of classifier as containing abnormal behavior of the object. As an example, the image block sequences in which the behavior of the object lasts very short time may be removed as noise. Particularly, it may be judged whether the lasting time of the behavior of the object in each image block sequence exceeds a predetermined threshold value (referred to as the first threshold value. It should be noted this threshold value may be predetermined based on the actual application scenarios and should not be limited to any particular value). If yes, the image block sequence is reserved; and otherwise it may be determined that the behavior of the object in this image block sequence is noise that does not containing abnormal behavior. As another example, the number of warnings occurred within a time period of a predetermined length (i.e. within a predetermined number of image frames) when using the previous stage of classifier to classify the image block sequence may be counted. When the number of warning is less than a predetermined threshold value (referred to as the second threshold value. It should be noted this threshold value may be predetermined based on the actual application scenarios and should not be limited to any particular value), the image block sequence may be determined as noise, and otherwise, the image block sequence is reserved.

As another example, a step of removing noise as shown by step 106-5 may also be performed before step 106-1.

By removing noise from the training samples before training each stage of classifier, the training efficiency may be improved and the detection accuracy of the classifier thus trained may be increased, thus further decreasing the error detection in the following abnormal behavior detection.

Next, an example of the method of extracting image block sequences corresponding to the moving range of an object to be detected from a video image sequence is described below with reference to FIG. 3 and FIG. 5.

In the example as shown in FIG. 3, the method of extracting image block sequences corresponding to the moving range of an object to be detected from a video image sequence may include steps 102-1, 102-2 and 102-3.

In step 102-1, the motion history image (MHI) of the video image is constructed.

Firstly the foreground region in the video image is detected. In the case of video monitoring, the image capturing device (e.g. camera) is generally stationary, and thus the background in the captured images is still while the object (e.g. a person) is moving. The motion region (foreground) in the video image may be detected by using any appropriate method, for example, the Gaussian mixture model (GMM) method may be used to model the background and detect the foreground (motion region) in each frame of image. As another example, the kernel density estimation) method or other appropriate method may be used, the description of which is not detailed herein.

FIG. 5(A) shows an example of video image containing the walking and falling down behaviors of an object (a person). FIG. 5(B) shows the foreground image sequence obtained by performing foreground detection on the video image shown in FIG. 5(A (by using the GMM method.

the MHI may be constructed using the foreground images of a plurality of image frames (e.g. the recent n frames of foreground images, n>1) based on the following formula:

$${H}_{τ} ( x , y , t ) = \{ \begin{matrix}τ , & ifD ( x , y , t ) = 1 \\ max ( 0 , {H}_{τ} ( x , y , t - 1 ) - 1 ) , & others\end{matrix} \qquad ( 1 )$$

In the formula, x, y and t represent the locations in the 3 directions of width, height and time of a pixel. τ is a constant, the value of which may be determined based on actual practice and should not be limited to any particular value. D(x, y, t) denotes the result of foreground detection, where if D(x, y, t)=1, the pixel (x, y, t) belongs to foreground. H_{τ}(x, y, t) denotes the motion history image (MHI).

FIG. 5(C) shows MHI obtained by processing the foreground images shown in FIG. 5(B) by using the above method, and FIG. 5(C1) is a partially amplified diagram of the part in the block shown in FIG. 5(C).

Then in step 102-2, a connected component analysis is performed on the video image based on the MHI to obtain the motion range of the object. Any appropriate connected component analysis method may be used, the description of which is not detailed herein. The block in FIG. 5(D) shows the motion region of the object (i.e. the motion range of the object) obtained by the connected component analysis by using the MHI shown in FIG. 5(C).

Finally in step 102-3, the image block corresponding to the motion range in each frame of image is extracted, to form the image block sequence corresponding to the motion range of the object. FIG. 5(E) shows the image block sequence extracted from the video image shown in FIG. 5(A), FIGS. 5(E1), (E2), and (E3) shows the image blocks in the image block sequence. The image block sequence contains the behavior of falling down of the object (in this example, a person) during walking.

In the example of FIG. 3, the connected component analysis is performed on MHI to obtain the motion range of the object. The motion range thus obtained corresponds to the motion range of the object in a plurality of frames of images. In contrast, in the method based on MHI but without the connected component analysis, the motion range obtained corresponds to only the moving range of the object in the current frame of image. Thus, compared with the method without connected component analysis, the motion range obtained by using the method of FIG. 3 may include much more effective information. And by using the detector trained based on such image block sequence, the detection accuracy of the abnormal behavior detector may be improved significantly, and the error detection may be decreased. It should be noted that the method of obtaining motion range of an object described with reference to FIG. 3 and FIG. 5 is merely an example. In other examples, other appropriate method may be used, for example, the Gaussian mixture model (GMM) method may be used to model the background and detect the foreground (motion range) in the each image frame, without performing the step of constructing MHI and performing connected component analysis; for another example, the kernel density estimation method may be used to detect foreground (motion range) in the each image to obtain the motion range of the object, the description of which is omitted herein. However, the motion range obtained by such method contains less effective information than that obtained by the method shown in FIG. 3 and FIG. 5.

FIG. 4 shows the flow chart of the method of generating a detector according to another embodiment. The detector is configured to detect the abnormal behavior of an object in video image. In the method shown in FIG. 4, the scenario being monitored is, and a detector including two or more stages of classifiers that are connected in series is trained for each of the sub-regions.

As shown in FIG. 4, the method may include steps 410, 402, 404, 414 and 406.

In step 410, the scenario included in the video samples is divided into a plurality of sub-regions, the number and locations of which may be determined based on actual practice and should not be limited to any particular values.

In step 402, an image block sequence containing image blocks corresponding to the motion range of the object in each image frame of each video sample is extracted from the video sample. The step 402 is similar to the step 102 described above in FIG. 1, and may use the method described above with reference to FIG. 3 and FIG. 5 or other appropriate method to extract the image block sequence, the description of which is not repeated herein.

Then in step 404, the motion vector feature in each image block sequence is extracted. In other words, the motion vector feature in the image block sequence extracted from each video sample is calculated. Step 404 is similar to step 104, the description of which is not repeated herein.

In step 414, each image block sequence is located. That is, it is determined in which sub-region of the monitored scenario each image block sequence is located. Then in step 406, a detector for detecting the abnormal behaviors of an object in the sub-region is generated by using the image block sequence in the sub-region and the motion vector feature thereof. Step 406 is similar to step 106 described above with reference to FIG. 1 and FIG. 2, the description of which is not repeated herein. In addition, similar to the above embodiments or examples, each stage of classifier may be trained by using any appropriate training method. For example, each stage of classifier of the two or more stages of classifiers that are connected in series may be a one class support vector machine. As another example, other training method, such as the training method based on a probability distribution model (the probability distribution model herein includes but not limited to Gaussian mixture model, Hidden Markov model, and Conditional Random Fields, and the like), may be used, the description of which is omitted herein. It should be noted that, in FIG. 1 step 414 is shown to be performed after step 404, however this is merely an example. In other example, step 414 may be performed before step 404.

With the method shown in FIG. 4, a plurality of abnormal behavior detectors may be obtained with the plurality of sub-regions of the monitored scenario. Each sub-region corresponds to a detector. The detector of each sub-region may include two or more stages of classifiers that are connected in series. In this way, the intra-variance resulted from perspective variation in the video image may be effectively handled, thereby further improving the accuracy of abnormal behavior detection and decreasing the error detection.

Referring back to FIG. 4, as an example, the method of generating a detector may further include a step of classifying the object (shown in dotted line bock 412). In an example in which the object to be detected is a person, it may be judged in step 412 whether the behavior contained in the image block sequence is a behavior of a person, and if yes, the image block sequence is further processed, otherwise, the image block sequence is discarded. The object classifying in step 412 may be performed by any appropriate method. For example, whether a behavior is the person's behavior may be determined based on the size of the region in which the image blocks are located. Such method is suitable for objects that have sizes different from each other (e.g. person, vehicle, animal, or the like). For another example, the method of detecting a person disclosed in Paul Viola et al. “Rapid Object Detection Using a Boosted Cascade of Simple Features” (CVPR, 2001) may be used, the description of which is not detailed herein. With the method, the samples which do not contain the object to be detected from the training samples, so as to further improve the efficiency of the training, increase the detection accuracy of the trained classifier, and further decrease the error detection in the following abnormal behavior detection.

As another example, the method of generating a detector may further include a step of extracting statistic information (e.g. as shown in dotted line block 416 of FIG. 4). Particularly, in step 416, the motion statistic information of the corresponding scenario may be calculated based on the motion vector feature extracted from a plurality of video samples. For example, the mean value and variance value and the like of the amplitude of the motion vector feature may be calculated as the motion statistic information. In the case that the monitored scenario is divided into a plurality of sub-regions, the motion statistic information of each sub-region may be extracted. These motion statistic information may be stored in a storage device (not shown) for the following abnormal behavior detection, so as to further improve the detection accuracy and decrease the error detection.

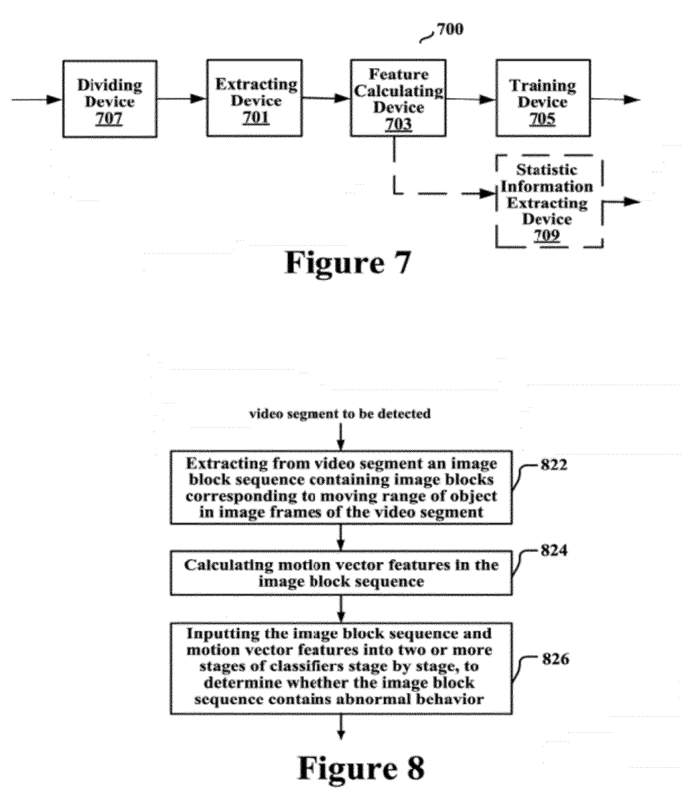

An embodiment of the apparatus of generating a detector according to the disclosure is described below with reference to FIG. 6 and FIG. 7. The detector herein is used to detect an abnormal behavior of an object in video.

FIG. 6 is a schematic block diagram illustrating the structure of an apparatus of generating a detector according to an embodiment of the disclosure.

As shown in FIG. 6, the apparatus 600 may include an extracting device 601, a feature calculating device 603 and a training device 605. The apparatus 600 of FIG. 6 generates the detector for detecting an abnormal behavior of an object in video by using a plurality of labeled video training samples.

The extracting device 601 is configured to extract, from each video sample, the image block sequence that contains the image blocks corresponding to the motion range of the object in each frame of image in a video sample. The extracting device 601 may extract the image block sequence by using the method described above with reference to FIG. 1, FIG. 3 or FIG. 5 or FIG. 4, the description of which is not repeated herein.

The extracting device 601 outputs the extracted image block sequence to the feature calculating device 603. The feature calculating device 603 calculates the motion vector feature in image block sequence extracted from each video sample. The feature calculating device 603 may calculate the motion vector feature by using the method described above with reference to FIG. 1 or FIG. 4, the description of which is not repeated herein.

The training device 605 generates the detector for detecting the abnormal behaviors of the object by using a plurality of image block sequences extracted by the extracting device 601 from a plurality of video samples as well as the motion vector features calculated by the feature calculating device 603. The training device 605 may use all the image block sequences to train the first stage of classifier, then utilize the first stage of classifier to classify the plurality of image block sequences and utilize the image block sequences, among the plurality of image block sequences, that are determined by the first stage of classifier as containing abnormal behavior to train the next stage of classifier, so as to obtain two or more stages of classifiers. The two or more stages of classifiers may be connected in series to form the detector for detecting the abnormal behaviors of the object. The training device 605 may train the detector by using the method described above with reference to FIG. 1, FIG. 2 or FIG. 4, the description of which is not repeated herein. Similar to the above method embodiment or example, the training device 605 may train each stage of classifier by using any appropriate training method. For example, each stage of the two or more stages of classifiers that are connected in series may be a one class support vector machine. For another example, the training device 605 may train each stage of classifier by using other training method, such as the training method based on the probability distribution model (the probability distribution model herein includes but not limited to Gaussian mixture model, Hidden Markov model, and Conditional Random Fields, and the like), the description of which is not repeated herein, either.

By using the training apparatus of FIG. 6, two or more stages of classifiers that are connected in series may be generated, where each stage of classifier is trained by using the samples classified by the previous stage of classifier. In this way, the type of samples, the number of which is small, may be modeled, thereby decreasing the error detection in the abnormal behavior detection.

FIG. 7 is a schematic block diagram illustrating the structure of an apparatus of generating a detector according to another embodiment of the disclosure. In addition to an extracting device 701, a feature calculating device 703 and a training device 705, the apparatus 700 of FIG. 7 further includes a dividing device 707.

The dividing device 707 is configured to divide the monitored scenario into a plurality of sub-regions. The number of sub-regions and the sizes thereof may be determined based on actual practice, the description of which is not detailed herein.

The extracting device 701 is similar to the extracting device 601, and is configured to extract, from each video sample, the image block sequence that contains the image blocks corresponding to the motion range of the object in each frame of image in a video sample. The extracting device 601 may extract the image block sequence by using the method described above with reference to FIG. 1, FIG. 3 or FIG. 5 or FIG. 4, the description of which is not repeated herein.

The feature calculating device 703 is similar to the feature calculating device 603, is configured to calculate the motion vector feature in image block sequence extracted from each video sample. The feature calculating device 603 may calculate the motion vector feature by using the method described above with reference to FIG. 1 or FIG. 4, the description of which is not repeated herein.

The training device 705 is configured to locate each image block sequence first, in other words, determine in which sub-region each image block sequence is located. Then, the training device 705 generate a detector for detecting the abnormal behavior of an object in each sub-region by using the image block sequence of each sub-region and the motion vector feature thereof. the training device 705 may train the detector for each sub-region by using the method described above with referent to FIG. 1, FIG. 2 or FIG. 4, the description of which is not repeated herein. In addition, similar to the above embodiment or example, each stage of classifier may be trained by using any appropriate method. For example, each stage of the two or more stages of classifiers for each sub-region may be a one class support vector machine. For another example, the training device 705 may train each stage of classifier by using other training method, such as the training method based on the probability distribution model (the probability distribution model herein includes but not limited to Gaussian mixture model, Hidden Markov model, and Conditional Random Fields, and the like), the description of which is not repeated herein, either.

By using the training apparatus of FIG. 7, a plurality of abnormal behavior detectors may be obtained with the plurality of sub-regions of the monitored scenario. Each sub-region corresponds to a detector. The detector of each sub-region may include two or more stages of classifiers that are connected in series. In this way, the intra-variance resulted from perspective variation in the video image may be effectively handled, thereby further improving the accuracy of abnormal behavior detection and decreasing the error detection.

As an example, before training the next stage of classifier by using the image block sequences that are determined by the previous stage of classifier as containing abnormal behavior of the object, the training device 705 may perform noise removing by using the method described above with reference to step 106-5. As an example, after the first stage of classifier is trained, the training device 705 may remove the noise from the image block sequences that are determined by the first stage of classifier as containing abnormal behavior of the object. As an example, the training device 705 may remove the image block sequences in which the behavior of the object lasts very short time as noise. Particularly, the training device 705 may judge whether the lasting time of the behavior of the object in each image block sequence exceeds a predetermined threshold value (It should be noted this threshold value may be predetermined based on the actual application scenarios and should not be limited to any particular value). If yes, the training device 705 reserves the image block sequence; and otherwise the training device 705 may determine that the behavior of the object in this image block sequence is noise that does not containing abnormal behavior. As another example, the training device 705 may count the number of warnings occurred within a time period of a predetermined length (i.e. within a predetermined number of image frames) when using the previous stage of classifier to classify the image block sequences. When the number of warning is less than a predetermined threshold value (It should be noted this threshold value may be predetermined based on the actual application scenarios and should not be limited to any particular value), the training device 705 may determine the image block sequence as noise, and otherwise, the training device 705 may reserve the image block sequence.

As another example, the apparatus 700 of generating a detector may further include a statistic information extracting device 709. The statistic information extracting device 709 may calculate the motion statistic information of the corresponding scenario based on the motion vector feature extracted from a plurality of video samples. For example, the statistic information extracting device 709 may calculate the mean value and variance value and the like of the amplitude of the motion vector feature, as the motion statistic information. In the case that the monitored scenario is divided into a plurality of sub-regions, the statistic information extracting device 709 may extract the motion statistic information of each sub-region. These motion statistic information may be stored in a storage device (not shown) for the following abnormal behavior detection, so as to further improve the detection accuracy and decrease the error detection

As another example, the training device 705 may further perform the process of classifying the object by using the method described above with reference to step 412. In an example in which the object to be detected is a person, the training device 705 may judge whether the behavior contained in the image block sequence is a behavior of a person, and if yes, may further process the image block sequence, otherwise, may discard the image block sequence. The training device 705 may perform the object classifying by any appropriate method. For example, whether a behavior is the person's behavior may be determined based on the size of the region in which the image blocks are located. Such method is suitable for objects that have sizes different from each other (e.g. person, vehicle, animal, or the like). For another example, the method of detecting a person disclosed in Paul Viola et al. “Rapid Object Detection Using a Boosted Cascade of Simple Features” (CVPR, 2001) may be used, the description of which is not detailed herein.

Some embodiments of the method of detecting abnormal behavior of an object in video by using two or more stages of classifiers that are connected in series are described below with reference to FIG. 8 to FIG. 12.

FIG. 8 is a schematic flow chart showing a method of detecting abnormal behavior of an object in video according to an embodiment.

As shown in FIG. 8, the method includes steps 822, 824 and 826.

In step 822, an image block sequence containing image blocks corresponding to the motion range of the object in each image frame of the video segment to be detected is extracted from the video segment. The method described above with reference to FIG. 1, FIG. 3 and FIG. 5 may be used to extract the image block sequence, the description of which is not repeated herein.

In step 824, the motion vector feature in the image block sequence is calculated. The method described above with reference to FIG. 1, FIG. 18 or FIG. 4 may be used to extract the motion vector feature in the image block sequence, the description of which is not repeated herein, either.

In step 826, the detector for detecting abnormal behavior of the object generated by using the method or apparatus described above with reference to FIG. 1 to FIG. 7 is used to detect whether the image block sequence contains an abnormal behavior of the object. FIG. 14 shows an example of the structure of such detector for detecting abnormal behavior. As shown in FIG. 14, the abnormal behavior detecting device 1305 may include the first stage of classifier 1305-1, the second stage of classifier 1305-2, . . . , the Nth stage of classifier 1305-N, where N≧2. Each stage of classifier is configured to detect abnormal behavior of the object. The image block sequence and the motion vector feature are input into N stages of classifiers stage by stage. If the previous stage of classifier determines that the image block sequence contains abnormal behavior, the image block sequence is input into the next stage of classifier, until the last stage of classifier.

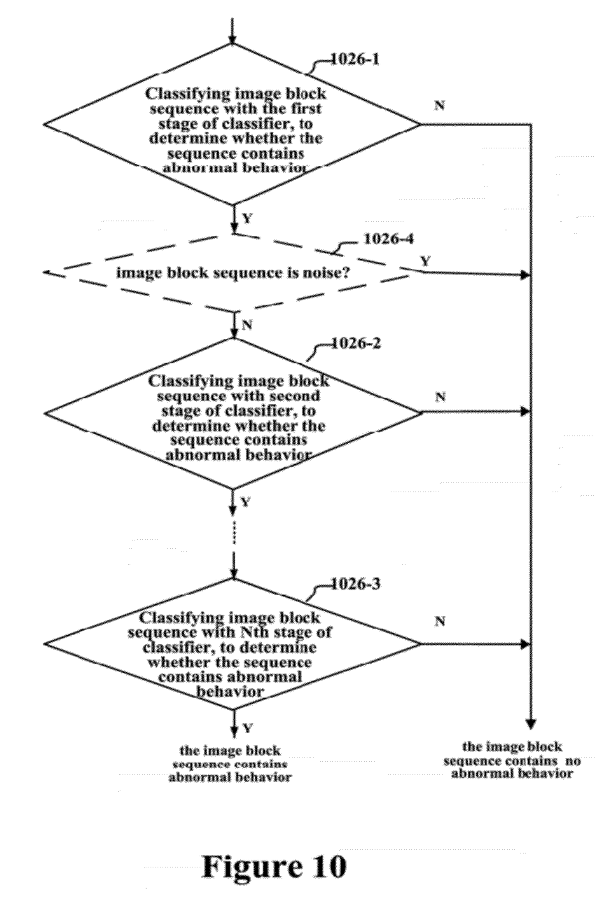

FIG. 10 shows an example of the method for detecting abnormal behavior of the object in the image block sequence by using N stages of classifiers that are connected in series (N≧2). As shown in FIG. 10, in step 1026-1 the first stage of classifier is used to classify the image block sequence, to determine whether the image block sequence contains the abnormal behavior of the object. If the first stage of classifier outputs a negative result, it may be determined that the image block sequence does not contain the abnormal behavior of the object, otherwise, the image block sequence is input into the next stage of classifier (step 1026-2). In step 1026-2, the second stage of classifier is used to classify the image block sequence, to determine whether the image block sequence contains abnormal behavior of the object. If the second stage of classifier outputs a negative result, it may be determined that the image block sequence does not contain the abnormal behavior of the object, otherwise, the image block sequence is input into the next stage of classifier, and the rest may be deduced by analogy, until the Nth stage of classifier. If the Nth stage of classifier outputs a negative result, it may be determined that the image block sequence does not contain the abnormal behavior of the object, otherwise, it may be determined that the image block sequence contains the abnormal behavior of the object (step 1026-3).

In the method shown in FIG. 8 two or more stages of classifiers that are connected in series are used to detect the abnormal behaviors of the object in video. The multi-stage judging method may decrease the error detection in the abnormal behavior detection and increase the detection accuracy.

As an example, each stage of classifier in the two or more stages of classifiers that are connected in series may be a one class support vector machine, that is, the two or more stages of classifiers that are connected in series may include one class support vector machines connected in series. As another example, each stage of classifier in the two or more stages of classifiers that are connected in series may be trained by using other training method, such as the training method based on a probability distribution model (the probability distribution model herein includes but not limited to Gaussian mixture model, Hidden Markov model, and Conditional Random Fields, and the like), the description of which is omitted herein.

Referring back to FIG. 10, as an example, after classifying the image blocks by using a stage of classifier and before further processing by the next stage of classifier, the method may include a step 1026-4 of judging whether the image block sequence is noise. In step 1026-4, it may be judged whether the lasting time of the behavior of the object in the image block sequence exceeds a predetermined threshold value (It should be noted this threshold value may be predetermined based on the actual application scenarios and should not be limited to any particular value). If no, it may be determined that the image block sequence contains no abnormal behavior of the object; and otherwise the image block sequence is input into the next stage of classifier. As another example, the number of warnings occurred within a time period of a predetermined length (i.e. within a predetermined number of image frames) when using the previous stage of classifier to classify the image block sequence may be counted. When the number of warning is less than a predetermined threshold value (It should be noted this threshold value may be predetermined based on the actual application scenarios and should not be limited to any particular value), the image block sequence may be determined as noise, and otherwise, the image block sequence is input into the next stage of classifier.

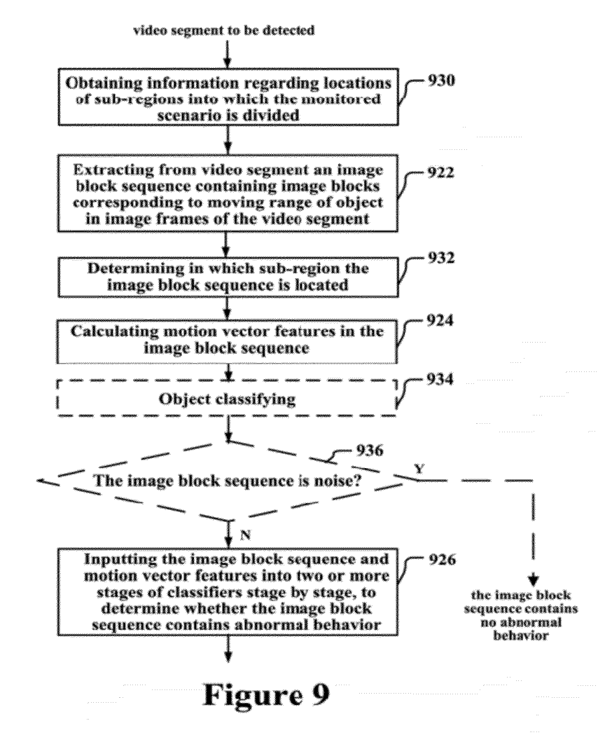

FIG. 9 is a schematic flow chart showing the method of detecting abnormal behavior of an object in video according to another embodiment. In the embodiment, the monitored scenario is divided into a plurality of sub-regions, and a plurality of detectors, each of which corresponds to a sub-region and includes two or more stages of classifiers connected in series, are used.

As shown in FIG. 9, the method includes steps 930, 922, 932, 924 and 926.

In step 930, the information regarding the locations of the plurality of sub-regions into which the scenario related to the captured video segment is obtained. For example, the information, such as the locations and/or number of the sub-regions divided when training the two or more stages of classifiers that are connected in series for each sub-region, may be stored in a storage device (not shown), and the information may be obtained from the storage device during the process of abnormal behavior detection.

In step 922, the image block sequence containing image blocks corresponding to the motion range of the object in each image frame of the video segment to be detected is extracted from the video segment. The method described above with reference to FIG. 1, FIG. 3 or FIG. 5 may be used to extract the image block sequence, the description of which is not repeated herein.

In step 932, it is determined in which sub-region the extracted image block sequence is located.

In step 924, the motion vector feature of the image block sequence is calculated. The method described above with reference to FIG. 1, FIG. 18 or FIG. 4 may be used to extract the motion vector feature in the image block sequence, the description of which is not repeated herein, either. Optionally, step 932 and step 924 may be performed in a reverse order, i.e. step 924 may be performed before step 932.

In step 926, the detector for detecting abnormal behavior generated by using the apparatus or method described above with reference to FIG. 4 or FIG. 7 is used to detect whether the image block sequence contains the abnormal behavior of the object. The detector for detecting abnormal behavior includes two or more stages of classifiers that are connected in series for each sub-region.

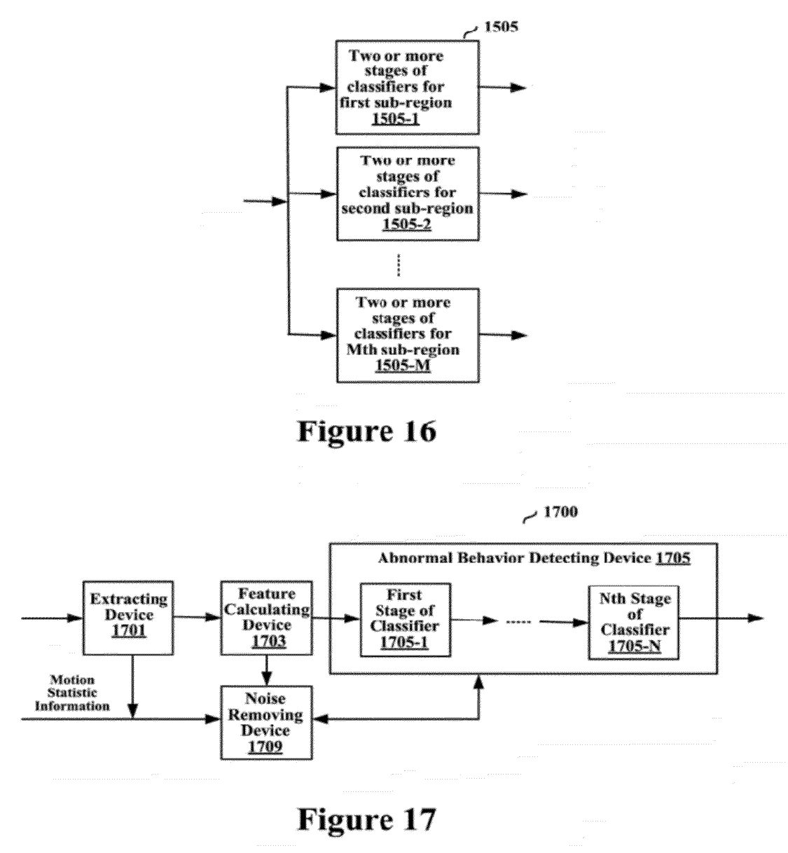

FIG. 16 shows an example of the structure of such detector for detecting abnormal behavior. As shown in FIG. 16, it is supposed that the monitored scenario is divided into M sub-regions (M>1), thus the abnormal behavior detecting device 1505 includes two or more stages of classifiers 1505-1 that are connected in series for the first sub-region, two or more stages of classifiers 1505-2 that are connected in series for the second sub-region, . . . , and two or more stages of classifiers 1505-M that are connected in series for the Mth sub-region. Based on the sub-region determined in step 932, the two or more stages of classifiers that are connected in series corresponding to the determined sub-region is used to detect whether the image block sequence contains abnormal behavior of the object. The detection may be performed by using the method described above with reference to FIG. 10, the description of which is not repeated herein.

In the method of FIG. 9, the monitored scenario is divided into a plurality of sub-regions, and the abnormal behavior detection is performed by using the two or more stages of classifiers that are connected in series for each sub-region. Each sub-region corresponds to a set of two or more stages of classifiers that are connected in series. With the method, the intra-variance resulted from perspective variation in the video image may be effectively handled, thereby further improving the accuracy of abnormal behavior detection and decreasing the error detection.

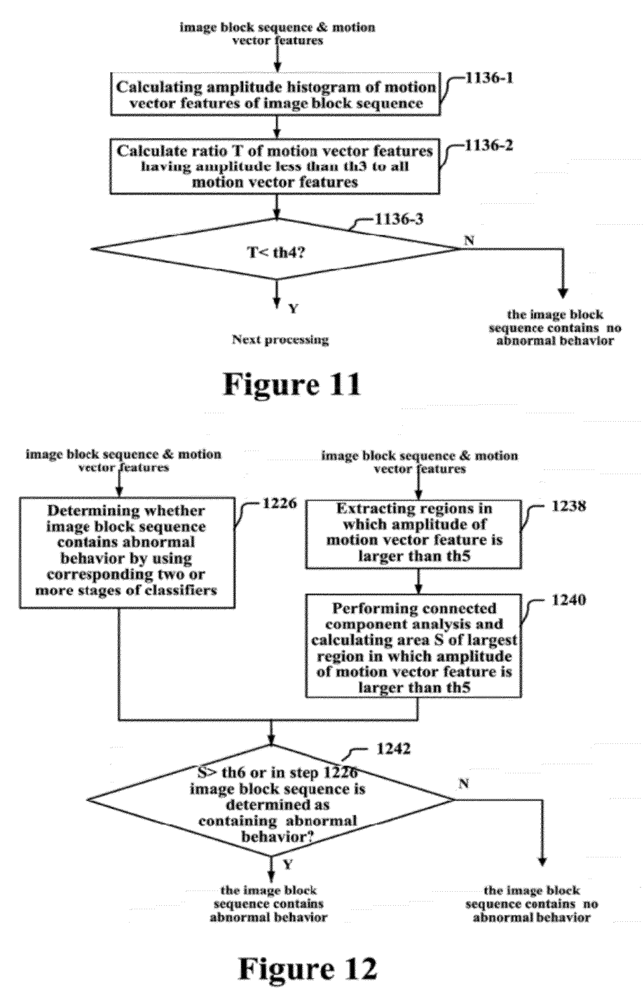

As an example, the extracted image block sequence may be preprocessed based on the motion statistic information of the monitored scenario which is extracted from the training samples during the process of training the classifier (e.g. step 936 in FIG. 9). In step 936, it is judged whether the extracted image block sequence is noise that does not contain abnormal behavior based on the motion statistic information of the monitored scenario. As described above, the motion statistic information may be the mean value and variance of the amplitudes of the motion vector features extracted from a plurality of video training samples. In the case that the monitored scenario is divided into a plurality of sub-regions, the motion statistic information of each sub-region may be extracted. These motion statistic information may be stored in a storage device (not shown) for the following abnormal behavior detection. FIG. 11 shows a particular example of preprocessing the image block sequence by using the motion statistic information. As shown in FIG. 11, in step 1136-1, the histogram of the amplitudes of the motion vector features of the image block sequence is calculated. The histogram may be calculated by using any appropriate method, the description of which is not detailed herein. Then in step 1136-2 the ratio T of motion vector features having an amplitude less than a predetermined threshold value th3 (referred to as the third threshold value) to all the motion vector features is calculated based on the histogram. As an example, th3=mean value+n1×variance. The mean value and variance refer to the mean value and variance of the amplitudes of the motion vector features extracted from a plurality of video training samples when generating the detector. n1 is a constant, the value of which may be predetermined based on actual practice and should not limited to any particular value. In step 1136-3, it is judged whether the ratio T is larger than a predetermined threshold th4 (referred to the fourth threshold value. It should be noted that, this threshold value may be predetermined based on actual practice and is not limited to any particular value), if no, it may be determined that the image block sequence contains no abnormal behavior; otherwise the processing proceeds to the following step, i.e. to process the image block sequence by using the corresponding two or more stages of classifiers that are connected in series. By preprocessing the image block sequence with the motion statistic information, noise may be removed, thereby further improving the efficiency of detection.

FIG. 12 shows another example of using the motion statistic information. As shown in FIG. 12, in step 1226 the image block sequence is detected by using two or more stages of classifiers that are connected in series. Step 1226 is similar to the above described step 826 or 926 or the method shown in FIG. 10, the description of which is not repeated herein. In step 1238, the region, in the image block sequence, in which the amplitude of the motion vector features is larger than a predetermined threshold value th5 (referred to as the fifth threshold value) is calculated. As an example, th5=mean value+n1×variance. The mean value and variance refer to the mean value and variance of the amplitudes of the motion vector features extracted from a plurality of video training samples when generating the detector. n1 is a constant, the value of which may be predetermined based on actual practice and should not limited to any particular value. Then in step 1240 a connected component analysis is performed on the image block sequence and then the area S of the largest region in which the amplitude of the motion vector features is larger than th5 is calculated.

Then in step 1242, it is judged whether the area S is larger than a predetermined threshold th6 (referred to as the sixth threshold value. It should be noted that, this threshold value may be predetermined based on actual practice and should not limited to any particular value), If S>th6 or if in step 1226 the image block sequence is determined as containing an abnormal behavior of the object, it may be determined that the image block sequence contains an abnormal behavior of the object; otherwise, it may be determined that the image block sequence contains no abnormal behavior of the object. By preprocessing the image block sequence with the motion statistic information, the accuracy of detection may be further improved and the error detection may be deceased.

Referring back to FIG. 9, as an example, the method of detecting the abnormal behavior of the object may further include a step of classifying the object (as shown in dotted line block 934 in FIG. 9). In an example in which the object to be detected is a person, in step 934 it may be judged whether the behavior contained in the image block sequence is a behavior of a person, and if yes, the image block sequence may be further processed, otherwise, the image block sequence may be discarded. The step 934 may perform the object classifying by any appropriate method. For example, whether a behavior is the person's behavior may be determined based on the size of the region in which the image blocks are located. Such method is suitable for objects that have sizes different from each other (e.g. person, vehicle, animal, or the like). For another example, the method of detecting a person disclosed in Paul Viola et al. “Rapid Object Detection Using a Boosted Cascade of Simple Features” (CVPR, 2001) may be used, the description of which is not detailed herein.

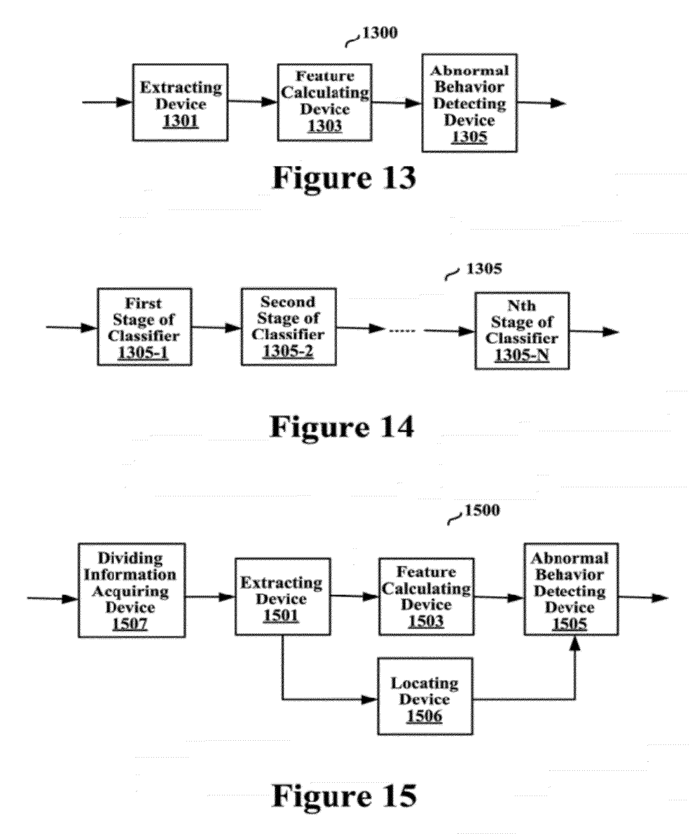

Some embodiments of the apparatus of detecting an abnormal behavior of an object in video according to the disclosure are described below with reference to FIG. 13 to FIG. 17.

FIG. 13 shows an apparatus of detecting an abnormal behavior of an object in video according to an embodiment of the disclosure.

As shown in FIG. 13, the apparatus 1300 may include an extracting device 1301, a feature calculating device 1303 and an abnormal behavior detecting device 1305.

The extracting device 1301 extracts, from the video segment to be detected, the image block sequence containing image blocks corresponding to the motion range of the object in each frame of image in the video segment. The extracting device 1301 may use the method described above with reference to FIG. 1, FIG. 3 or FIG. 5 to extract the image block sequence, the description of which is not repeated herein.

The feature calculating device 1303 calculates the motion vector features in the image block sequence. The feature calculating device 1303 may use the method described above with reference to FIG. 1, FIG. 18 or FIG. 4 to calculate the motion vector features in the image block sequence, the description of which is not repeated herein, either.

The abnormal behavior detecting device 1305 is configured to detect whether the image block sequence contains an abnormal behavior based on the motion vector features. FIG. 14 shows an example of the structure of the abnormal behavior detecting device 1305. As shown in FIG. 14, the abnormal behavior detecting device 1305 includes N stages of classifiers that are connected in series including the first stage of classifier 1305-1, the second stage of classifier 1305-2, . . . , the Nth stage of classifier 1305-N. The image block sequence and the motion vector features are input into the N stages of classifiers stage by stage. If a previous stage of classifier determines that the image block sequence contains an abnormal behavior, the image block sequence is input into the next stage of classifier, until the last stage of classifier. The abnormal behavior detecting device 1305 may perform the detection by using the method described above with reference to FIG. 10, the description of which is not repeated herein.

The apparatus of FIG. 13 includes two or more stages of classifiers that are connected in series for detecting the abnormal behaviors of the object. With such multi-stage detecting apparatus, the error detection may be decreased in abnormal behavior detection, thereby improving the accuracy of the detection.

As an example, each stage of classifier 1305-i (i=1, 2, . . . , N) may be a one class support machine, that is, the abnormal behavior detecting device 1305 may include one class support machines connected in series. As another example, each stage of classifier may be a classifier trained by using other training method, such as the training method based on a probability distribution model (the probability distribution model herein includes but not limited to Gaussian mixture model, Hidden Markov model, and Conditional Random Fields, and the like), may be used, the description of which is omitted herein.

FIG. 15 shows an apparatus of detecting an abnormal behavior of an object in video according to another embodiment.

As shown in FIG. 15, in addition to an extracting device 1501, a feature calculating device 1503 and an abnormal behavior detecting device 1505, the apparatus 1500 further includes a dividing information acquiring device 1507 and a locating device 1506.

The dividing information acquiring device 1507 is configured to obtain the information regarding the locations of a plurality of sub-regions into which the monitored scenario related to the video segment is divided. For example, the information, such as the locations and/or number of the sub-regions divided when training the two or more stages of classifiers that are connected in series for each sub-region, may be stored in a storage device (not shown), and the dividing information acquiring device 1507 may obtain the information from the storage device during the process of abnormal behavior detection. The abnormal behavior detecting device 1505 may include two or more stages of classifiers that are connected in series for each sub-region. FIG. 16 shows an example of the structure of such detector for detecting abnormal behavior. As shown in FIG. 16, it is supposed that the monitored scenario is divided into M sub-regions (M>1), thus the abnormal behavior detecting device 1505 includes two or more stages of classifiers 1505-1 that are connected in series for the first sub-region, two or more stages of classifiers 1505-2 that are connected in series for the second sub-region, . . . , and two or more stages of classifiers 1505-M that are connected in series for the Mth sub-region. When dividing the scenario into sub-regions, the locations and number of the sub-regions should correspond to the structure of the abnormal behavior detecting device 1505 to be used, so that each of M sub-regions corresponds to one of M sets of two or more stages of classifiers that are connected in series 1505-i (i=1, . . . , M, M>1).

The extracting device 1501 extracts, from the video segment to be detected, the image block sequence containing image blocks corresponding to motion range of the object in each image frame of the video segment. The extracting device 1501 may extract the image block sequence by using the method described above with reference to FIG. 1, FIG. 3 or FIG. 5, the description of which is not repeated herein.

The feature calculating device 1503 calculates the motion vector features in the image block sequence. The feature calculating device 1503 may calculate the motion vector features by using the method described above with reference to FIG. 1, FIG. 18 or FIG. 4, the description of which is not repeated herein, either.

The locating device 1506 is configured to determine in which sub-region the extracted image block sequence is located, so as to output the image block sequence and the calculated motion vector features into the corresponding two or more stages of classifiers 1505-i that are connected in series (i=1, . . . , M, M>1) in the abnormal behavior detecting device 1505. Each set of two or more stages of classifiers 1505-i that are connected in series has the structure shown in FIG. 14, i.e. includes N stages of classifiers (N≧2).

In the apparatus of FIG. 15, the monitored scenario is divided into a plurality of sub-regions, and the abnormal behavior detection is performed by using the two or more stages of classifiers that are connected in series for each sub-region. Each sub-region corresponds to a set of two or more stages of classifiers that are connected in series. With the apparatus, the intra-variance resulted from perspective variation in the video image may be effectively handled, thereby further improving the accuracy of abnormal behavior detection and decreasing the error detection.

FIG. 17 shows the structure of an apparatus of detecting an abnormal behavior of an object in video according to another embodiment. The apparatus 1700 is of similar structure to the apparatus 1300 in FIG. 13. The difference lies in that the apparatus 1700 further include a noise removing device 1709.

The extracting device 1701, the feature calculating device 1703, and the abnormal behavior detecting device 1705 are similar to the extracting device 1301, the feature calculating device 1303, and the abnormal behavior detecting device 1305 in structure and function, respectively, the description of which is not repeated herein.

The noise removing device 1709 may preprocess the extracted image block sequence based on the motion statistic information of the monitored scenario related to the video segment. As an example, the noise removing device 1709 judges whether the extracted image block sequence is noise that does not contain abnormal behavior based on the motion statistic information of the monitored scenario. As described above, the motion statistic information may be the mean value and variance of the amplitudes of the motion vector features extracted from a plurality of video training samples. In the case that the monitored scenario is divided into a plurality of sub-regions, the motion statistic information of each sub-region may be extracted. These motion statistic information may be stored in a storage device (not shown) for the following abnormal behavior detection. The noise removing device 1709 may use the method described above with reference to FIG. 11 to preprocess the image block sequence by using the motion statistic information, the description of which is not repeated herein. By preprocessing the image block sequence with the motion statistic information, noise may be removed, thereby further improving the efficiency of detection.

As another example, the noise removing device 1709 may use the method shown in FIG. 12 to process the image block sequence. Particularly, after the abnormal behavior detecting device 1705 detects the image block sequence by using two or more stages of classifiers that are connected in series, the noise removing device 1709 may process the image block sequence by using the method shown in steps 1238, 1240 and 1242 in FIG. 12, the description of which is not repeated herein. By processing the image block sequence with the motion statistic information, the accuracy of detection may be further improved and the error detection may be deceased.

As another example, the noise removing device 1709 may further judges whether the image block sequence is noise. Particularly, the noise removing device 1709 may judge whether the lasting time of the behavior of the object in the image block sequence exceeds a predetermined threshold value (It should be noted this threshold value may be predetermined based on the actual application scenarios and should not be limited to any particular value). If no, it may be determined that the image block sequence is noise that contains no abnormal behavior of the object. As another example, the noise removing device 1709 may count the number of warnings occurred within a time period of a predetermined length (i.e. within a predetermined number of image frames) when using the previous stage of classifier to classify the image block sequence. When the number of warning is less than a predetermined threshold value (It should be noted this threshold value may be predetermined based on the actual application scenarios and should not be limited to any particular value), the image block sequence may be determined as noise. For example, the noise removing device 1709 may perform the above processing after the abnormal behavior detecting device 1705 classifies the image blocks by using each stage of classifier and before performing further judgment by using the next stage of classifier.

As another example, the noise removing device 1709 in the apparatus of detecting an abnormal behavior of an object in video may further classify the object. In an example in which the object to be detected is a person, the noise removing device 1709 may judge whether the behavior contained in the image block sequence is a behavior of a person, and if yes, further process the image block sequence, otherwise, discard the image block sequence. The noise removing device 1709 may perform the object classifying by any appropriate method. For example, the noise removing device 1709 may determine whether a behavior is the person's behavior based on the size of the region in which the image blocks are located. Such method is suitable for objects that have sizes different from each other (e.g. person, vehicle, animal, or the like). For another example, the method of detecting a person disclosed in Paul Viola et al. “Rapid Object Detection Using a Boosted Cascade of Simple Features” (CVPR, 2001) may be used, the description of which is not detailed herein.

The apparatus and method of detecting an abnormal behavior of an object in video according to embodiment of the disclosure may be applied to any appropriate location that is installed with a video monitoring apparatus (e.g. cameras), especially the locations having high security requirements, such as airport, bank, park, and military base, and the like.

Some embodiments of the disclosure provide a video monitoring system (not shown). The video monitoring system includes a video collecting device configured to capture a video of a monitored scenario. The video monitoring system further includes the above described apparatus of detecting an abnormal behavior of an object in video, the description of which is not repeated herein.

It should be understood that the above embodiments and examples are illustrative, rather than exhaustive. The present disclosure should not be regarded as being limited to any particular embodiments or examples stated above. In addition, some expressions in the above embodiments and examples contain the word “first” or “second” or the like (e.g. the first threshold value, the second threshold value, etc.). As can be understood by those skilled in the art such expressions are merely used to literally distinguish the terms from each other and should not be regarded as any limiting to such as the sequence thereof. In addition, in the above embodiments and examples, the steps and devices are represented by numerical symbols. As can be understood by those skilled in the art such numerical symbols are merely used to literally distinguish the terms from each other and should not be regarded as any limiting to such as the sequence thereof.

As an example, the components, units or steps in the above apparatuses and methods can be configured with software, hardware, firmware or any combination thereof. As an example, in the case of using software or firmware, programs constituting the software for realizing the above method or apparatus can be installed to a computer with a specialized hardware structure (e.g. the general purposed computer 1900 as shown in FIG. 19) from a storage medium or a network. The computer, when installed with various programs, is capable of carrying out various functions.

In FIG. 19, a central processing unit (CPU) 1901 executes various types of processing in accordance with programs stored in a read-only memory (ROM) 1902, or programs loaded from a storage unit 1908 into a random access memory (RAM) 1903. The RAM 1903 also stores the data required for the CPU 1901 to execute various types of processing, as required. The CPU 1901, the ROM 1902, and the RAM 1903 are connected to one another through a bus 1904. The bus 1904 is also connected to an input/output interface 1905.

The input/output interface 1905 is connected to an input unit 1906 composed of a keyboard, a mouse, etc., an output unit 1907 composed of a cathode ray tube or a liquid crystal display, a speaker, etc., the storage unit 1908, which includes a hard disk, and a communication unit 1909 composed of a modem, a terminal adapter, etc. The communication unit 1909 performs communicating processing. A drive 1910 is connected to the input/output interface 1905, if needed. In the drive 1910, for example, removable media 1911 is loaded as a recording medium containing a program of the present invention. The program is read from the removable media 1911 and is installed into the storage unit 1908, as required.

In the case of using software to realize the above consecutive processing, the programs constituting the software may be installed from a network such as Internet or a storage medium such as the removable media 1911.

Those skilled in the art should understand the storage medium is not limited to the removable media 1911, such as, a magnetic disk (including flexible disc), an optical disc (including compact-disc ROM (CD-ROM) and digital versatile disk (DVD)), an magneto-optical disc (including an MD (Mini-Disc) (registered trademark)), or a semiconductor memory, in which the program is recorded and which are distributed to deliver the program to the user aside from a main body of a device, or the ROM 1902 or the hard disc involved in the storage unit 1908, where the program is recorded and which are previously mounted on the main body of the device and delivered to the user.

The present disclosure further provides a program product having machine-readable instruction codes which, when being executed, may carry out the methods according to the embodiments.

Accordingly, the storage medium for bearing the program product having the machine-readable instruction codes is also included in the disclosure. The storage medium includes but not limited to a flexible disk, an optical disc, a magneto-optical disc, a storage card, or a memory stick, or the like.

In the above description of the embodiments, features described or shown with respect to one embodiment may be used in one or more other embodiments in a similar or same manner, or may be combined with the features of the other embodiments, or may be used to replace the features of the other embodiments.

As used herein, the terms the terms “comprise,” “include,” “have” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

Further, in the disclosure the methods are not limited to a process performed in temporal sequence according to the order described therein, instead, they can be executed in other temporal sequence, or be executed in parallel or separatively. That is, the executing orders described above should not be regarded as limiting the method thereto.

While some embodiments and examples have been disclosed above, it should be noted that these embodiments and examples are only used to illustrate the present disclosure but not to limit the present disclosure. Various modifications, improvements and equivalents can be made by those skilled in the art without departing from the scope of the present disclosure. Such modifications, improvements and equivalents should also be regarded as being covered by the protection scope of the present disclosure.

What is claimed is:

1. An abnormal behavior detecting apparatus, comprising:
an extracting device, configured to extract, from a video segment to be detected, an image block sequence containing a plurality of image blocks corresponding to a moving range of an object in each image frame in the video segment;
a feature calculating device, configured to calculate motion vector features of the image block sequence; and
an abnormal behavior detecting device comprising two or more stages of classifiers that are connected in series, wherein the two or more stages of classifiers are configured to receive the image block sequence and the motion vector features stage by stage and detect the abnormal behavior of the object, if a previous stage of classifier determines that the image block sequence contains an abnormal behavior, a next stage of classifier further receives and detects the image block sequence, until last stage of classifier.

2. The abnormal behavior detecting apparatus according to claim 1, wherein the extracting device is configured to extract the image block sequence by:
constructing a motion history image of the video segment;
performing a connected component analysis according to the motion history image to obtain the moving range of the object; and
extracting the image blocks corresponding to the moving range from each image frame in the video segment, to form the image block sequence.

3. The abnormal behavior detecting apparatus according to claim 1, wherein each stage of the two or more stages of classifiers is a one class support vector machine.

4. The abnormal behavior detecting apparatus according to claim 1, further comprising:
a dividing information acquiring device, configured to obtain information regarding locations of a plurality of sub-regions into which a scenario related to the video segment is divided; and
a locating device, configured to determine in which sub-region the extracted image block sequence is located,
wherein the abnormal behavior detecting device comprises a plurality of sets of two or more stages of classifiers that are connected in series, each set of two or more stages of classifiers corresponds to a sub-region of the plurality of sub-regions.

5. The abnormal behavior detecting apparatus according to claim 1, further comprising a noise removing device, configured to judge whether a lasting time of a behavior of the object in the image block sequence exceeds a second threshold value, and if no, determine the behavior of the object in the image block sequence as noise.

6. The abnormal behavior detecting apparatus according to claim 1, further comprising a noise removing device configured to calculate a ratio of motion vector features having an amplitude less than a third threshold value to all of the motion vector features based on an amplitude histogram of the motion vector features of the image block sequence, and if the ratio is larger than or equal to a fourth threshold value, determine the image block sequence as noise.

7. The abnormal behavior detecting apparatus according to claim 6, wherein the third threshold value meets:
th3=mean value+n1×variance,
wherein th3 denotes the third threshold value; the mean value and the variance denote a mean value and a variance of motion vector features extracted from a plurality of video samples, respectively; and n1 denotes a constant.

8. The abnormal behavior detecting apparatus according to claim 1, further comprising a noise removing device configured to: extract, from the image block sequence, regions in which amplitude of motion vector feature is larger than a fifth threshold value; perform a connected component analysis and calculate an area of a largest region in which amplitude of motion vector feature is larger than the fifth threshold value; and if the area is less than or equal to a sixth threshold value, determine the image block sequence as noise.

9. The abnormal behavior detecting apparatus according to claim 8, wherein the fifth threshold value meets:
th5=mean value+n1×variance
wherein th5 denotes the fifth threshold value; the mean value and the variance denote a mean value and a variance of motion vector features extracted from a plurality of video samples, respectively; and n1 denotes a constant.

10. An abnormal behavior detecting method, comprising:
extracting, from a video segment to be detected, an image block sequence containing a to plurality of image blocks corresponding to a moving range of an object in each image frame in the video segment;
calculating motion vector features of the image block sequence; and
detecting the image block sequence and the motion vector features by two or more stages of classifiers that are connected in series stage by stage, wherein the two or more stages of classifiers are configured to receive the image block sequence and the motion vector features stage by stage and detect the abnormal behavior of the object, if a previous stage of classifier determines that the image block sequence contains an abnormal behavior, a next stage of classifier further receives and detects the image block sequence, until last stage of classifier.

11. The abnormal behavior detecting method according to claim 10, wherein extracting the image block sequence comprises:
constructing a motion history image of the video segment;
performing a connected component analysis according to the motion history image to obtain the moving range of the object; and
extracting the image blocks corresponding to the moving range from each image frame in the video segment, to form the image block sequence.

12. The abnormal behavior detecting method according to claim 10, wherein each stage of the two or more stages of classifiers is a one class support vector machine.

13. The abnormal behavior detecting method according to claim 10, further comprising: dividing a scenario related to the video segment into a plurality of sub-regions, and
wherein after extracting the image block sequence, the method further comprises: determining in which sub-region the extracted image block sequence is located, and
wherein the abnormal behavior detecting device comprises a plurality of sets of two or more stages of classifiers that are connected in series, each set of two or more stages of classifiers corresponds to a sub-region of the plurality of sub-regions.

14. The abnormal behavior detecting method according to claim 10, further comprising: judging whether a lasting time of a behavior of the object in the image block sequence exceeds a second threshold value, and if no, determining the behavior of the object in the image block sequence as noise.

15. The abnormal behavior detecting method according to claim 10, further comprising: calculating a ratio of motion vector features having an amplitude less than a third threshold value to all of the motion vector features based on an amplitude histogram of the motion vector features of the image block sequence, and if the ratio is larger than or equal to a fourth threshold value, determining the image block sequence as noise.

16. The abnormal behavior detecting method according to claim 15, wherein the third threshold value meets:
th3=mean value+n1×variance,
wherein th3 denotes the third threshold value; the mean value and the variance denote a mean value and a variance of motion vector features extracted from a plurality of video samples, respectively; and n1 denotes a constant.

17. The abnormal behavior detecting method according to claim 10, further comprising: extracting, from the image block sequence, regions in which amplitude of motion vector feature is larger than a fifth threshold value; performing a connected component analysis and calculating an area of a largest region in which amplitude of motion vector feature is larger than the fifth threshold value; and if the area is less than or equal to a sixth threshold value, determining the image block sequence as noise.

18. A video monitoring system, comprising:
a video collecting device, configured to capture a video of a monitored scenario; and
an abnormal behavior detecting apparatus configured to detect an abnormal behavior of an object in the video and comprising:
an extracting device, configured to extract, from a video segment to be detected, an image to block sequence containing a plurality of image blocks corresponding to a moving range of an object in each image frame in the video segment;
a feature calculating device, configured to calculate motion vector features of the image block sequence; and
an abnormal behavior detecting device comprising two or more stages of classifiers that are connected in series, wherein the two or more stages of classifiers are configured to receive the image block sequence and the motion vector features stage by stage and detect the abnormal behavior of the object, if a previous stage of classifier determines that the image block sequence contains an abnormal behavior, a next stage of classifier further receives and detects the image block sequence, until last stage of classifier.

19. A program product, comprising program codes which, when loaded into a memory of a computer and executed by a processor of the computer, cause the processor to perform the following steps of:
extracting, from a video segment to be detected, an image block sequence containing a plurality of image blocks corresponding to a moving range of an object in each image frame in the video segment;
calculating motion vector features of the image block sequence; and
detecting the image block sequence and the motion vector features by two or more stages of classifiers that are connected in series stage by stage, wherein the two or more stages of classifiers are configured to receive the image block sequence and the motion vector features stage by stage and detect the abnormal behavior of the object, if a previous stage of classifier determines that the image block sequence contains an abnormal behavior, a next stage of classifier further receives and detects the image block sequence, until last stage of classifier.

20. A recording medium, that stores program codes which, when loaded into a memory of a computer and executed by a processor of the computer, cause the processor to perform the following steps of:
extracting, from a video segment to be detected, an image block sequence containing a plurality of image blocks corresponding to a moving range of an object in each image frame in the video segment;
calculating motion vector features of the image block sequence; and
detecting the image block sequence and the motion vector features by two or more stages of classifiers that are connected in series stage by stage, wherein the two or more stages of classifiers are configured to receive the image block sequence and the motion vector features stage by stage and detect the abnormal behavior of the object, if a previous stage of classifier determines that the image block sequence contains an abnormal behavior, a next stage of classifier further receives and detects the image block sequence, until last stage of classifier.
